(19) United States
(12) Patent Application Publication
(10) Pub. No.: US 2026/0172522 A1
(43) Pub. Date: Jun. 18, 2026

(54) SYSTEMS AND METHODS FOR ENCODING INFORMATION IN DOCUMENTS

(71) Applicant: Xerox Corporation, Norwalk, CT (US)

(72) Inventors: Sainarayanan GopaIakrishnan, Chennai (IN); Rajasekar Kanagasabai, Chennai (IN); Vignesh Doss, Palanichettipatti (IN)

(21) Appl. No.: 18/979,842

(22) Filed: Dec. 13, 2024

(51) Int. Cl. H04N 1/32; G06V 30/148

(52) U.S. Cl. CPC H04N 1/32272; G06V 30/153; H04N 1/32224

(57) ABSTRACT

Systems and methods for operating a system. The methods comprise: obtaining a message in a human readable format; converting the human readable format of the message into a colored dot pattern format; and encoding the message in a printed document or an electronic document by applying colored dots to the printed or electronic document in accordance with the colored dot pattern format and in a manner that minimizes visibility of the colored dots. The converting involves: mapping each character in the message to a mapping character, performing optical character recognition to recognize characters in the electronic document that are the same as the mapping characters in the character mapped message, tagging the recognized characters in the electronic document, detecting an edge of each tagged character, segmenting the detected edge into edge sections, assigning each edge section to a category, and obtaining dot colors and positions for characters of each word.

### BACKGROUND

### Description of the Related Art

Technologies exist for printing electronic documents on sheets of media, and scanning/copying printed documents. These technologies have been employed in commercial products such as printers, plotters, scanners, copiers, facsimile machines, and/or multifunctional devices. In some scenarios, specialty imaging is added to the electronic documents prior to being printed for security purposes. Adding specialty imaging on electronic documents for security purposes continues to be of interest to businesses. It is challenging to add special patterns to a document with hidden information such that they are not visually explicit. Conventional methods exist for adding special patterns to documents. These conventional methods include, for example, applying watermarks to documents, applying IRmarks to documents, and applying confidentiality labels to documents. Watermarks, IRmarks and/or confidentiality labels applied to documents are visually explicit. The explicit nature of these types of specialty imaging makes it easy for individuals to tamper with the same.

### SUMMARY

The present disclosure concerns implementing systems and methods for operating a system. The method comprises: obtaining, by a processor, a message in a human readable format; converting, by the processor, the human readable format of the message into a colored dot pattern format; and encoding the message in an electronic document by applying colored dots to the electronic document in accordance with the colored dot pattern format and in a manner that minimizes visibility of the colored dots.

The present disclosure further concerns a system comprising: a processor; and a non-transitory computer-readable medium comprising one or more programming instructions that when executed by the processor, cause the processor to: obtain a message in a human readable format; convert the human readable format of the message into a colored dot pattern format; and encode the message in an electronic document by applying colored dots to the electronic document in accordance with the colored dot pattern format and in a manner that minimizes visibility of the colored dots.

### BRIEF DESCRIPTION OF THE DRAWINGS

The present solution will be described with reference to the following drawing figures, in which like numerals represent like items throughout the figures.

FIG. 1 provides an illustration of a system implementing the present solution.

FIG. 2 provides an illustration showing an architecture for a printer.

FIG. 3 provides a block diagram of an illustrative architecture for a computing device.

FIG. 4 provides an illustration of a character mapping table.

FIG. 5 provides illustrations showing a user defined message mapped to a character mapped message.

FIG. 6 provides an illustration of an electronic document.

FIG. 7 provides an illustration of an electronic document with tagged characters of interest.

FIG. 8 provides an illustration that is useful for understanding edge detection and categorization operations.

FIGS. 9A-9B (collectively referred to as “FIG. 9”) show an illustrative encode table.

FIGS. 10A-10C (collectively referred to as “FIG. 10”) provide illustrations that are useful for understanding how the encode table of FIG. 9 is used to encode a message in an electronic document.

FIGS. 11A-11C (collectively referred to as “FIG. 11”) provide a flow diagram of an illustrative method for encoding a message in an electronic document.

FIGS. 12A-12B (collectively referred to as “FIG. 12”) provide a flow diagram of an illustrative method for decoding an encoded message of an electronic document.

### DETAILED DESCRIPTION

Adding specialty imaging on documents for security purposes continues to be of interest to businesses. It is challenging to add special patterns to a document with hidden information such that they are not visually explicit. Conventional methods exist for adding special patterns to documents. These conventional methods include, for example, applying watermarks to documents, applying IRmarks to documents, and applying confidentiality labels to documents. Watermarks, IR marks and/or confidentiality labels applied to documents are visually explicit. The explicit nature of these types of specialty imaging makes it easy for hackers to tamper with the same. Thus, there is a need for an alternative method to provide printed documents with added special marks or patterns that are invisible, non-tamperable, less visually explicit, less complex, and easy to encode and decode in a copy or scan with strong security features. The present solution provides such an alternative method.

The present solution concerns implementing systems and methods to encode information by making use of actual document content. The present solution effectively uses a character mapping table and an encode lookup table(s) (LUT(s)) to encode the information in a document. The LUT(s) enable(s) the system to tag characters with a defined edge-based color-coding technique, such that they are invisible or substantially invisible to individuals. This character tagging feature of the present solution enables copies and print jobs to imprint the information defined by an organization or a user. The encoded message and/or information enables control over the document handling.

The present solution has certain advantages. For example, the present solution can be easily implemented in a software image path, provides a specialty image feature for document security, allows for the creation of unique LUTs for color coding based on customer requirements, provides encoded information that is not easily visible to general users, allows secure stamps to be retained and/or transferred between digital and print media, requires less computation to implement, and provides for an enhances user experience.

The present solution generally involves performing encoding operations by a computing device to (i) map messages to obtain characters of interest, (ii) filter the characters of interest, (iii) perform edge detection on the filtered characters of interest, (iv) categorize each text resulting from the edge detection, access encode LUT(s), and (v) mark corresponding color dots along edges of the text based on contents of encode LUT(s). The message mapping operation (i) may involve: defining message and/or information that needs to be encoded; use a pre-defined character mapping table to map text in the message and/or information; and consider the mapped text as comprising the character of interest in an input document. The filtering operations (ii) may involve: performing optical character recognition (OCR) on the input document; and sorting the characters of interest based on selection and number of occurrences. If there are multiple instances of a character of interest in a content, then the system selects and applies filtering based on an input encoded value. If a character of interest is not present in the content, then the system selects a next character of the encoded value and applies a corresponding color to make detection thereof relatively easy. The edge detection and classification operations (iii) and (iv) may involve: performing canny edge detector on filtered characters; and categorize each text to a plurality of sections (e.g., six sections). The sections can include, but are not limited to, a vertical split and two horizontal splits. The encoding operations (v) may involve: accessing the encode LUT(s) that enclose defined information on word order, text order, edge tag position and their respective color codes; and marking corresponding color dots along the edges of the texts in their respective position based on the contents of the encode LUT(s).

The present solution also involves performing decoding operations by a device to perform edge detection when scanning or copying a printed document to identify or detect color dots along the edges thereof, validating candidates of the identified or detected color dots, using encode LUT(s) to obtain an ordered set of encoded characters associated with the validated candidates, and use character mapping table(s) to decode the encoded characters. The validating operations may involve keyword validation such that the system prompts the user to validate for same keyword. On right keying of the keyword, the system may allow the user to perform the defined actions (e.g., allowing to copy not scan or allowing to copy and/or scan only particular non-confidential pages or even restricting any actions). Wrong keying may be defined to restrict the job being proceeded and intimating an administrator on such breaches.

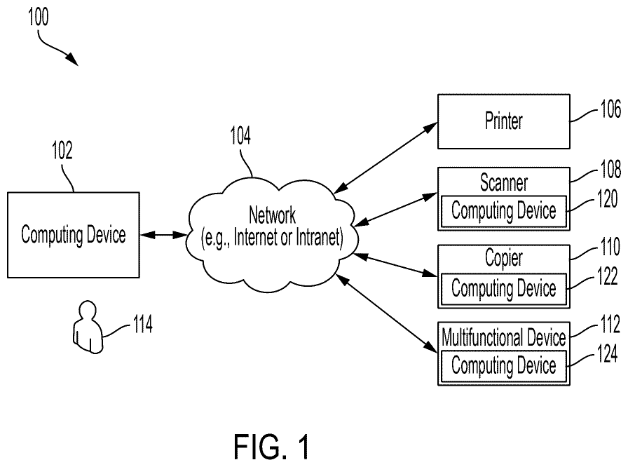

FIG. 1 provides an illustration of a system 100 configured to encode security messages in electronic documents and/or electronic images. System 100 comprises a computing device 102 that an individual 114 can use to create, store and/or modify electronic document(s) and/or electronic image(s). The individual 114 may also use computing device 102 to enter a user defined message to be encoded into the electronic document(s) and/or electronic image(s). The user defined message may be encoded into the electronic document(s) and/or image(s) at the computing device 102 or at a remote device 106, 112. In this regard, computing device 102 is configured to communicate data to a printer 106 and/or a multifunctional device 112 via network 104. Network 104 can include, but is not limited to, the Internet or an Intranet. The data can include, but is not limited to, electronic document(s), electronic image(s), image data, and/or user defined message(s) (which may or may not be encoded into the electronic document(s) or image(s). The manner in which the user defined message is encoded into the electronic document(s) and/or image(s) will become evident as the discussion progresses. Still, it should be understood that the user defined message is generally encoded in the electronic document/image by adding colored dots to edges of characters therein.

The electronic document(s)/image(s) may be printed by the printer 106 and/or multifunctional device 112 on sheet(s) of media. The printed document/image can then be scanned by a scanner 108 and/or multifunctional device 112, and/or copied by a copier 110 or the multifunctional device 112. When scanning or copying, device(s) 108, 110, 112 may perform edge detection operations to find the colored dots along the edges of characters within the scanned or copied document and perform decoding operations to re-generate the user defined message based on the color of the dots, the positions of the dots relative to character edges, and the characters to which the colored dots were applied. The manner in which the decoding is achieved will become evident as the discussion progresses. Still, it should be noted here that each of the devices 108, 110, 112 comprises a computing device 122, 124 that may be configured to perform the decoding operations of the present solution. The computing device 124 of the multifunctional device 112 may also be configured to perform the encoding operations of the present solution.

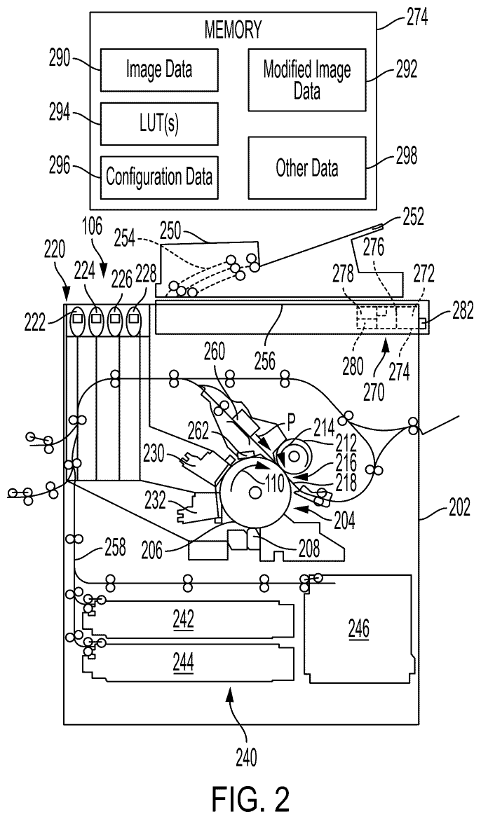

FIG. 2 shows an illustrative architecture for the printer 106. Printer 106 is configured to print images using ink drops having one or more drop sizes based on multi-bit halftoned image data. Printer 106 comprises a frame 202, an image receiving member 204, an actuator 208, and a transfix roller 212. Operating subsystems and components of printer 106 are mounted directly or indirectly to the frame. The image receiving member 204 is shown in the form of a rotatable imaging drum, but can equally be in the form of a supported endless belt. The image receiving member 204 has an image receiving surface 206, which provides a surface for formation of ink images. Actuator 204 can include, but is not limited to, a servo or electric motor. Actuator 204 engages the image receiving member 204 and is configured to rotate the image receiving member in direction 210. The transfix roller 212 is rotatable in the direction 214 and loads against the surface 206 of drum 204 to form a transfix nip 216 within which ink images formed on the surface 206 are transfixed onto a heated print medium 218.

Printer 106 also comprises a phase change ink delivery subsystem 220 that has multiple sources of different color phase change inks in solid form. Since printer 106 is a multicolor printer, the ink delivery subsystem 220 includes ink sources 222, 224, 226, 228. Each printhead assembly is configured to apply ink of one or more colors. The ink colors include cyan (C), magenta (M), yellow (Y), and black (K). The ink delivery subsystem 220 also includes a melting and control apparatus (not shown) for melting or phase changing the solid form of the phase change ink into a liquid form. Each of the ink sources 222, 224, 226, 228 includes a reservoir used to supply the melted ink to the printhead assemblies 230 and 232.

Printhead assemblies 230 and 232 may receive melted CMYK ink from the ink sources 222-228, and eject ink drops of one or more sizes. For example, a relatively small ink drop may be ejected from printhead assembly 230, and a relatively large ink drop may be ejected from printhead assembly 232. Alternatively or additionally, ink drops of different sizes may be ejected from inkjet(s) of a single printhead assembly. The image receiving surface is moved past the inkjet(s) for multiple passes to enable ink to be dropped onto the image receiving surface. Multiple ink drops may be applied at individual pixel locations to form composite drops with larger composite drop sizes.

Printer 106 also includes a substrate supply and handling subsystem 240, a document feeder 250, a document sheet feeding and retrieval devices 254, and a document exposure and scanning subsystem 256. Subsystem 240 comprises sheet or substrate supply sources 242, 244, 246. Supply source 246 can include, but is not limited to, a high capacity paper supply or feeder for storing and supplying image receiving substrates in the form of a cut sheet print medium 218. A media transport path 258 extracts print media, such as individually cut media sheets, from the system 240 and moves the print media in a process direction P. The media transport path 258 passes the print medium 218 through a substrate heater or pre-heater assembly 260. Assembly 260 heats the print medium 218 prior to transfixing an ink image to the print medium 218 in the transfix nip 216.

Media sources 242, 244, 246 provide image receiving substrates that pass through media transport path 258 to arrive at transfix nip 216 formed between the image receiving member surface 206 and transfix roller 212 in timed registration with the ink image formed on the image receiving surface 206. As the ink image and media travel through the transfix nip 216, the ink image is transferred from the surface 206 and fixedly fused to the print medium 218 within the transfix nip 216. In a duplexed configuration, the media transport path 258 passes the print medium 218 through the transfix nip 206 a second time for transfixing of a second ink image to a second side of the print medium 218.

Operation and control of the various subsystems, components and functions of printer 106 are performed with the aid of a controller 270. Controller 270 can include, but is not limited to, a self-contained, dedicated mini-computer having a central processor unit (CPU) 272 with a digital memory 274 and a user interface (UI) 276. Controller 270 may comprise a sensor input and control circuit 278 and an ink drop placement and control circuit 280. Control circuit 280 may be implemented as a field programmable gate array (FPGA). CPU 272 is configured to read, capture, prepare and manage the image data flow associated with print jobs received from image input sources (e.g., scanning system 256) or a remote device via interface 282. Controller 270 is the main multi-tasking processor for operating and controlling all of the other printer subsystems and functions.

Controller 270 can be implemented with general or specialized programmable processors that execute programmed instructions, for example, printhead operation. The instructions and data required to perform the programmed functions are stored in the memory 274. Controller 270 configures printer 106 to form ink images by controlling the operations of inkjets in the printhead assemblies 232, 234.

Memory 274 includes one or more non-volatile data storage devices, such as solid state, magnetic, or optical data storage devices, in addition to volatile memory such as random access memory (RAM). Memory 274 stores various information. This information can include, but is not limited to, image data 290, LUT(s) 294, mapped image data 292, configuration data 296, and other data 298. The other data 298 can include, but is not limited to, instruction(s). Image data 290 can include a two-dimensional array of pixels corresponding to one or more images that the printer 106 forms during a printing operation. Controller 270 can perform a halftoning process that is known to the art to convert a continuous tone (contone) image into a device-specific color space for the printer 106 and generate multi-bit halftoned image data that directly corresponds to the physical arrangement of drops and drop sizes in a final printed image. The LUTs 294 can include, but are not limited to, encode LUT(s) and/or character mapping LUT(s). The encode LUT(s) include(s) defined information on word order, text order, edge tag position, and respective color codes therefore. The character mapping LUT(s) include information for mapping text in a document to characters of interest. The LUT(s) 294 may be used to generate modified image data 292 in which colored dots have been added to encode a message in a document represented by the image data 290.

During operation, the printer 106 ejects a plurality of ink drops from inkjets in the printhead assemblies 232, 234 onto the surface 206 of the image receiving member 204. Controller 270 generates electrical firing signals to operate individual inkjets in one or both of the printhead assemblies 232, 234. Controller 270 processes digital image data corresponding to one or more printed pages in a print job, and generates image data 290 comprising bits maps for each of the CMYK color separations. Each bit map includes a two dimensional arrangement of pixels corresponding to locations on the image receiving member 204. Each pixel can have one or more potential values that indicate (i) whether the pixel is activated or deactivated, and or (ii) which size of ink drop or combination of ink drops should be printed for an activated pixel. Controller 270 generates a firing signal to activate an inkjet and eject a drop of ink onto the image receiving member 204 for the activated pixels, but does not generate a firing signal for the deactivated pixels. The combined bit maps for each of the colors of ink in the printer 106 generate multicolor or monochrome images that are subsequently transfixed to the print medium 216. The controller 270 generates the bit maps with selected activated pixel locations to enable the printer 106 to produce multi-color images, half-toned images, dithered images, and the like.

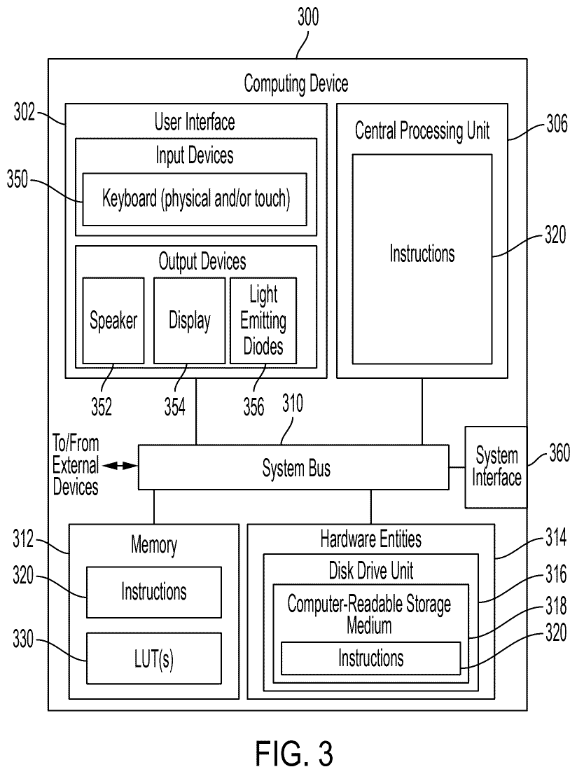

FIG. 3 shows an illustrative architecture for a computing device 300. Computing device(s) 102, 120, 122, 124 of FIG. 1 and/or controller 270 of FIG. 2 is/are the same as or similar to computing device 200. As such, the discussion of computing device 200 is sufficient for understanding the computing devices 102, 120, 122, 124 of FIG. 1 and controller 370 of FIG. 3.

Computing device 300 may include more or less components than those shown in FIG. 3. However, the components shown are sufficient to disclose an illustrative solution implementing the present solution. The hardware architecture of FIG. 3 represents one implementation of a representative computing device configured to receive information, process the receive information, transmit information and/or control operations of an aerial vehicle, as described herein. As such, the computing device 300 of FIG. 3 implements at least a portion of the method(s) described herein.

Some or all components of the computing device 300 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

Computing device 300 comprises a user interface 302, a Central Processing Unit (CPU) 306, a system bus 310, a memory 312 connected to and accessible by other portions of computing device 300 through system bus 310, a system interface 360, and hardware entities 314 connected to system bus 310. The user interface can include input devices and output devices, which facilitate user-software interactions for controlling operations of the computing device 300. The input devices include, but are not limited to, a physical and/or touch keyboard 350. The input devices can be connected to the computing device 300 via a wired or wireless connection (e.g., a Bluetooth® connection). The output devices include, but are not limited to, a speaker 352, a display 354, and/or light emitting diodes 356. System interface 360 is configured to facilitate wired or wireless communications to and from external devices (e.g., network nodes such as access points, etc.).

At least some of the hardware entities 314 perform actions involving access to and use of memory 312, which can be a Random Access Memory (RAM), a disk drive, flash memory, and/or another hardware device that is capable of storing instructions and data. Hardware entities 314 can include a disk drive unit 316 comprising a computer-readable storage medium 318 on which is stored one or more sets of instructions 320 (e.g., software code) configured to implement one or more of the methodologies, procedures, or functions described herein. LUT(s) 330 may also be stored on the computer-readable medium 318. The instructions 320 can also reside, completely or at least partially, within the memory 312 and/or within the CPU 306 during execution thereof by the computing device 300. The LUTs 394 can include, but are not limited to, encode LUT(s) and/or character mapping LUT(s). The encode LUT(s) include(s) defined information on word order, text order, edge tag position, and respective color codes therefore. The character mapping LUT(s) include information for mapping text in a document to characters of interest. The LUT(s) 330 may be used to generate modified electronic document(s) and/or modified image data in which colored dots have been added to encode a message therein.

The memory 312 and the CPU 306 also can constitute machine-readable media. The term “machine-readable media”, as used here, refers to a single medium or multiple media (e.g., a centralized or distributed database, and/or associated caches and servers) that store the one or more sets of instructions 320. The term “machine-readable media”, as used here, also refers to any medium that is capable of storing, encoding or carrying a set of instructions 320 for execution by the computing device 300 and that cause the computing device 300 to perform any one or more of the methodologies of the present disclosure.

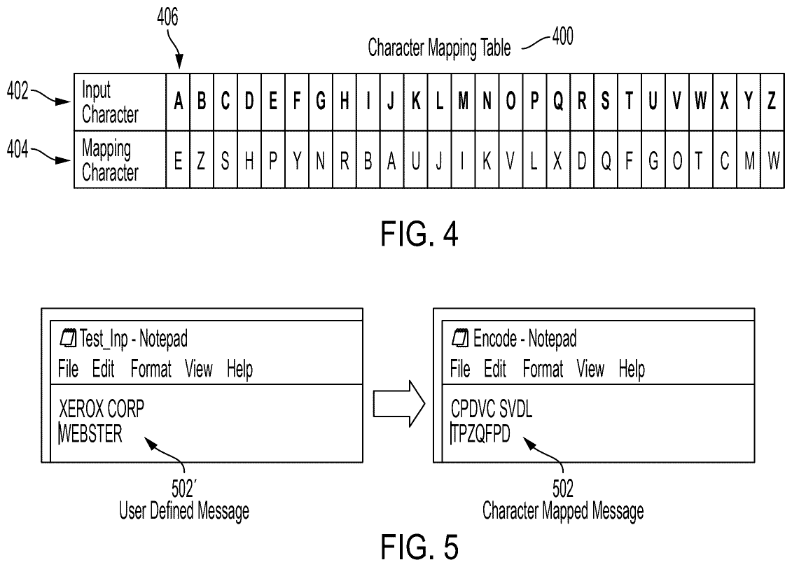

As noted above, the present solution involves mapping each character of a user defined message using one or more character mapping tables. The character mapping table(s) may comprise LUT(s). An illustrative character mapping table 400 is provided in FIG. 4. The character mapping table comprise two rows 402, 404 and a plurality of columns 406. A first row contains input characters, while the second row 404 contains mapping characters. The input characters can include, but are not limited to, at least some of the letters in the alphabet, numbers, icons, emojis and other symbols. The mapping characters can include, but are not limited to, some or all of the letters in the alphabet, numbers, icons, emojis and other symbols.

For example, as shown in FIG. 4, the input characters comprise A, B, C, D, E, F,. Z. Similarly, the mapping characters comprise the same letters in a different order than the input characters. Each letter in the input character row 402 may be mapped to a letter in the mapping character row 404 that resides in the same column. For example, an input character A is associated with a mapping character E, while an input character B is associated with a mapping character Z. An input character C is associated with a mapping character S, and so on. The present solution is not limited to the particulars of this example. Other mapping techniques may be used.

The words may be limited to N, while the characters in each word may be limited to M. Each of N and M is an integer equal to or greater than one. For example, N may be selected to four in accordance with a given application, while M is selected to be nine. The pre-defined character mapping table 400 may be used by the system to map the text in a message. For example, as shown in FIG. 5, a user defines a message 502′ that is to be encoded into a document. The message 502′ includes the text XEROX CORP followed by the name WEBSTER. The user defined message 502′ may be mapped to a character mapped message 502 in accordance with the character mapping table 400. Specifically, the five letter word “XEROX” is mapped to the five letter character string “CPDVC”. The four letter word “CORP” is mapped to the four letter character string “SVDL”. The seven letter name “WEBSTER” is mapped to the seven letter character string “TPZQFPD”. The present solution is not limited to the particulars of this example.

Once the input characters of the user-defined message are mapped to the mapping characters, the system performs OCR on the given input document to identify characters of interest. The characters of interest are selected to be the same as the characters of the character mapped message. For example, the characters of interest include the same characters as the character mapped message 502, i.e., CPDVC SVDL TPZQFPD. It should be noted that the characters of interest may appear in a different order than that of the character mapped message 502 and/or may have different case or capitalization of text as compared to that of the letters in the character mapped message 502. The characters of interest are then tagged by the system.

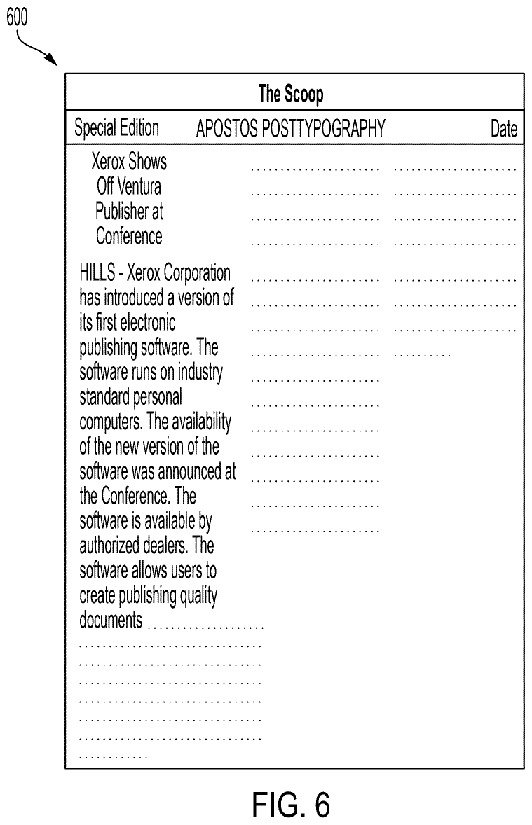

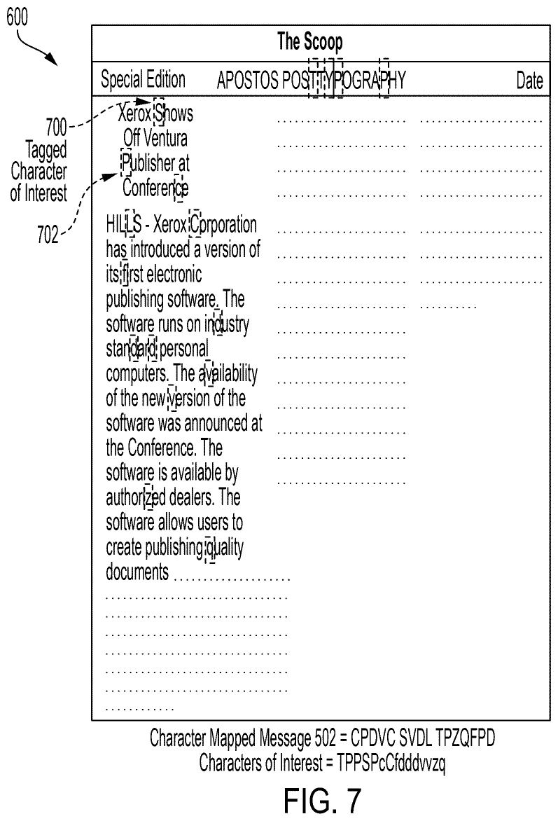

An illustrative input document 600 is shown in FIG. 6 that is to have a user defined message encoded therein. The OCR operations identify characters of interest within the text of the document based on the letters of the character mapped message 502. The tagged characters of interest 700 are shown in FIG. 7. The character tagging can involve overlaying a transparent shaped object over each character of interest. The shaped object can include, but is not limited to, a rectangle or square.

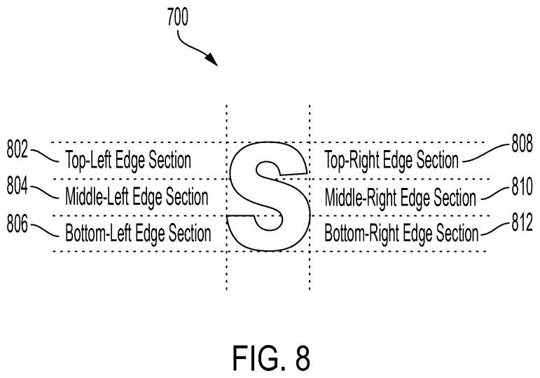

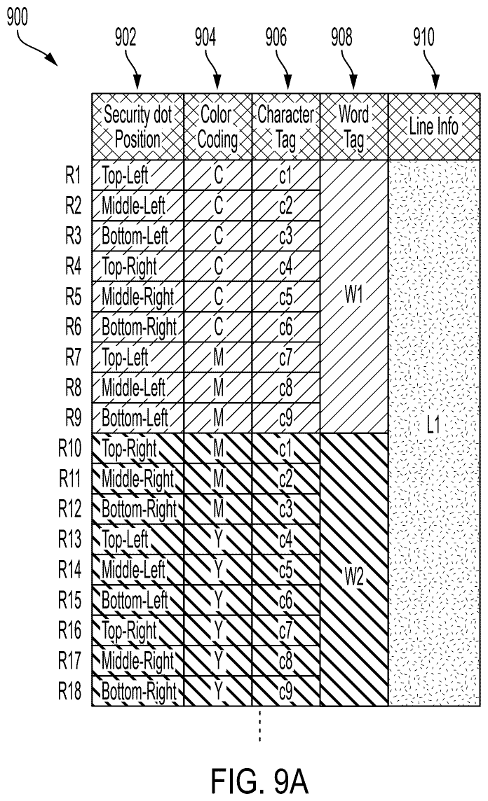

The tagged characters of interest are then used by an edge detection algorithm. The edge detection algorithm analyzes each tagged character of interest and categorizes the same into a plurality of edge sections. For example, as shown in FIG. 8, the tagged character of interest 700 comprises a capital S. The capital S is analyzed and portions of its edge are categorized into a top-left edge section 802, a top-right edge section 808, a middle-left edge section 804, a middle-right edge section 810, a bottom-left edge section 806, and a bottom-right edge section 812.

Once edges of the tagged characters of interest are categorized into edge sections, the system accesses encode LUT(s) stored in a datastore. The edge LUT(s) provide information that is useful in determining where colored dots are to be placed in the input document for encoding the user-defined message therein. The encoding technique involves adding a dot to the input document on the edge of each tagged character of interest. The edge location of a letter where the dot is to be formed is determined based on (i) the edge categorizations for the letter and (ii) contents of the encode LUT.

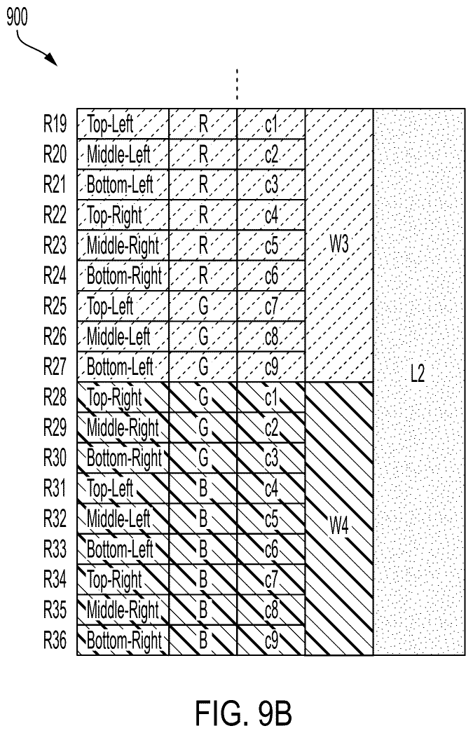

An illustrative encode LUT 900 is provided in FIGS. 9A-9B. The encode LUT 900 comprises five columns 902-910. The first column 902 includes a list of possible security dot positions for each tagged character of interest. The possible security dot positions include a top-left position, a middle-left position, bottom-left position, top-right position, a middle-right position, and a bottom-right position.

The second column 904 includes color assignments for each character of each word. It should be noted here that each word is limited to nine (9) characters c1-c9, and the total number of words that can be encoded in the input document is limited to four (4) words W1-W4. Cyan C is assigned to the first six characters c1, c2, c3, c4, c5, c6 of the first word W1. Magenta M is assigned to the last three characters c7, c8, c9 of the first word W1 and to the first three characters c1, c2, c3 of the second word W2. Yellow Y is assigned to remaining characters c4-c9 of the second word W2. Red R is assigned to the first sixth characters c1, c2, c3, c4, c5, c6 of the third word W3. Green G is assigned to the remaining characters c7, c8, c9 of the third word W3 and the first three characters c1, c2, c3 of the fourth word W4. Blue B is assigned to the remaining characters c4-c9 of the fourth word W4.

The third column 906 includes information for assigning each possible security dot position to a respective one of the nine (9) characters of each of the four (4) words. For example, the top-left dot position is assigned to the first character c1 of each of the four words W1-W4, while the middle-left dot position is assigned to the second character c2 of each of the four words W1-W4. The bottom-left dot position is assigned to the third character c3 of each of the four words W1-W4, and so on.

The fourth column 908 includes information specifying which rows are associated with each of the four words W1, W2, W3, W4. For example, rows R1-R9 are associated with the first word. Rows R10-R18 are associated with the second word. Rows R11-R27 are associated with the third word. Rows R28-R36 are associated with the fourth row. The fifth column 910 includes information specifying the lines of the character mapped message in which each word resides. Since the character mapped message 502 includes only two lines, the first column 910 includes line identifiers L1, L2 indicating that first and second words W1, W2 reside in a first line L1 of the message, while third and fourth words W3, W4 resides in a second line L2 of the message.

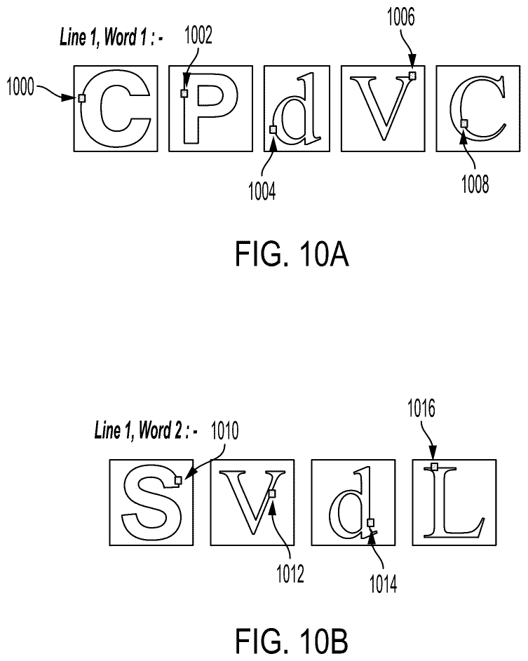

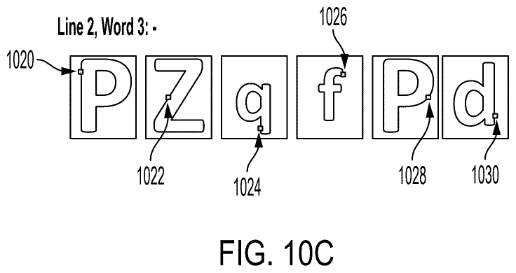

FIGS. 10A-10C provide illustrations that are useful for understanding how the encode LUT 900 is applied to the tagged characters of interest in the input document 600. The first character string of the character mapped message 502 is CPDVC. The corresponding tagged characters in the input document 600 include CPdVC as shown in FIG. 10A. The second character string of the character mapped message 502 is SVDL. The corresponding tagged characters in the input document 600 include SVdL as shown in FIG. 10B. The third character string in the character mapped message 502 is TPZQFPD. The corresponding tagged characters in the input document 600 include PZqfPd as shown in FIG. 10C.

With reference to FIG. 10A, a first letter “C” of the first character string CPdVC corresponds to the first character c1 of the first word W1 in the encode LUT 900. The encode LUT 900 specifies that a cyan dot is to be formed in a top-left position of the first character c1. Accordingly, cyan dot 1000 has been formed on the top-left edge of the tagged character “C” in the input document. The second letter “P” of the first character string CPdVC corresponds to the second character c2 of the first word W1 in the encode LUT 900. The encode LUT 900 specifies that a cyan dot is to be formed in a middle-left position of the second character c2. As such, cyan dot 1002 has been formed on the middle-left edge of the tagged character “P” in the input document. The third letter “d” of the first character string CPdVC corresponds to the third character c3 of the first word W1 in the encode LUT 900. The encode LUT 900 specifies that a cyan dot is to be formed in a bottom-left position of the third character c3. Thus, cyan dot 1004 has been formed on the bottom-left edge of the tagged character “d” in the input document. The fourth character “V” of the first character string CPdVC corresponds to the fourth character c4 of the first word W1 in the encode LUT 900. The encode LUT 900 specifies that a cyan dot is to be formed in a top-right position of the fourth character c4. Cyan dot 1006 has been formed on the top-right edge of the fourth character “V” in the input document. The last character “C” of the first character string CPdVC corresponds to the fifth character c5 of the first word W1 in the encode LUT 900. The encode LUT 900 specifies that a cyan dot is to be formed in a middle-right position of the fifth character c5. Accordingly, cyan dot 1008 has been formed on the middle-right edge of the tagged character “C” in the input document.

With reference to FIG. 10B, a first letter “S” of the second character string SVdL corresponds to the first character c1 of the second word W2 in the encode LUT 900. The encode LUT 900 specifies that a magenta dot is to be formed in a top-right position of the first character c1 of the second word W2. Accordingly, magenta dot 1010 has been formed on the top-right edge of the tagged character “S” in the input document. The second letter “V” of the second character string SVdL corresponds to the second character c2 of the second word W2 in the encode LUT 900. The encode LUT 900 specifies that a magenta dot is to be formed in a middle-right position of the second character c2 of the second word W2. As such, magenta dot 1012 has been formed on the middle-right edge of the tagged character “V” in the input document. The third letter “d” of the second character string SVdL corresponds to the third character c3 of the second word W2 in the encode LUT 900. The encode LUT 900 specifies that a magenta dot is to be formed in a bottom-right position of the third character c3 of the second word W2. As such, magenta dot 1014 has been formed on the bottom-right edge of the tagged character “d” in the input document. The fourth letter “L” of the second character string SVdL corresponds to the fourth character c4 of the second word W2 in the encode LUT 900. The encode LUT 900 specifies that a yellow dot is to be formed in a top-left position of the fourth character c4 of the second word W2. As such, yellow dot 1016 has been formed on the top-left edge of the tagged character “L” in the input document.

With reference to FIG. 10C, a first letter “P” of the third character string PZqfPd corresponds to the first character c1 of the third word W3 in the encode LUT 900. The encode LUT 900 specifies that a red dot is to be formed in a top-left position of the first character c1 of the third word W3. Accordingly, red dot 1020 has been formed on the top-left edge of the tagged character “P” in the input document. The second letter “Z” of the third character string PZqfPd corresponds to the second character c2 of the third word W3 in the encode LUT 900. The encode LUT 900 specifies that a red dot is to be formed in a middle-left position of the second character c2 of the third word W3. As such, red dot 1022 has been formed on the middle-left edge of the tagged character “Z” in the input document. The third letter “q” of the second character string PZqfPd corresponds to the third character c3 of the third word W3 in the encode LUT 900. The encode LUT 900 specifies that a red dot is to be formed in a bottom-left position of the third character c3 of the third word W3. As such, red dot 1024 has been formed on the bottom-left edge of the tagged character “q” in the input document. The fourth letter “f” of the third character string PZqfPd corresponds to the fourth character c4 of the third word W3 in the encode LUT 900. The encode LUT 900 specifies that a red dot is to be formed in a top-right position of the fourth character c4 of the third word W3. As such, red dot 1026 has been formed on the top-right edge of the tagged character “f” in the input document. The fifth letter “P” of the third character string PZqfPd corresponds to the fifth character c5 of the third word W3 in the encode LUT 900. The encode LUT 900 specifies that a red dot is to be formed in a middle-right position of the fifth character c5 of the third word W3. As such, red dot 1028 has been formed on the middle-right edge of the tagged character “P” in the input document. The sixth letter “d” of the third character string PZqfPd corresponds to the sixth character c6 of the third word W3 in the encode LUT 900. The encode LUT 900 specifies that a red dot is to be formed in a bottom-right position of the sixth character c6 of the third word W3. As such, red dot 1030 has been formed on the bottom-right edge of the tagged character “d” in the input document.

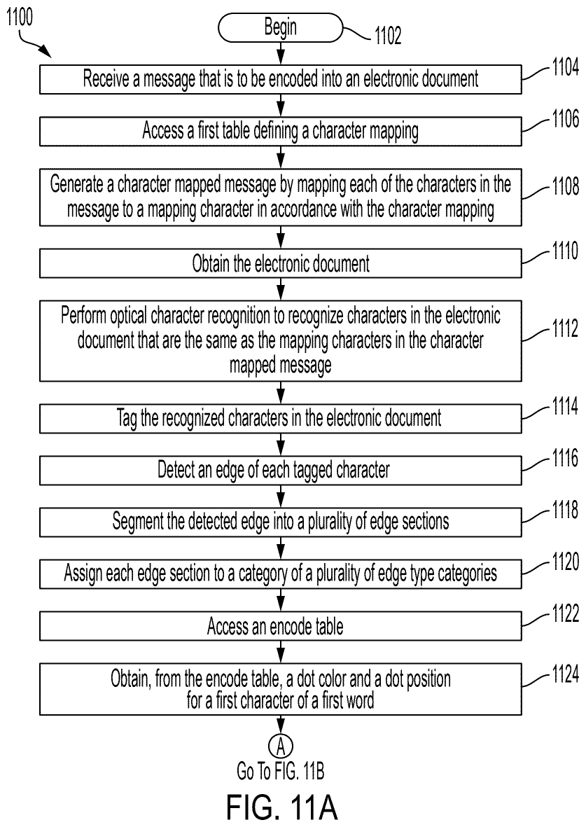

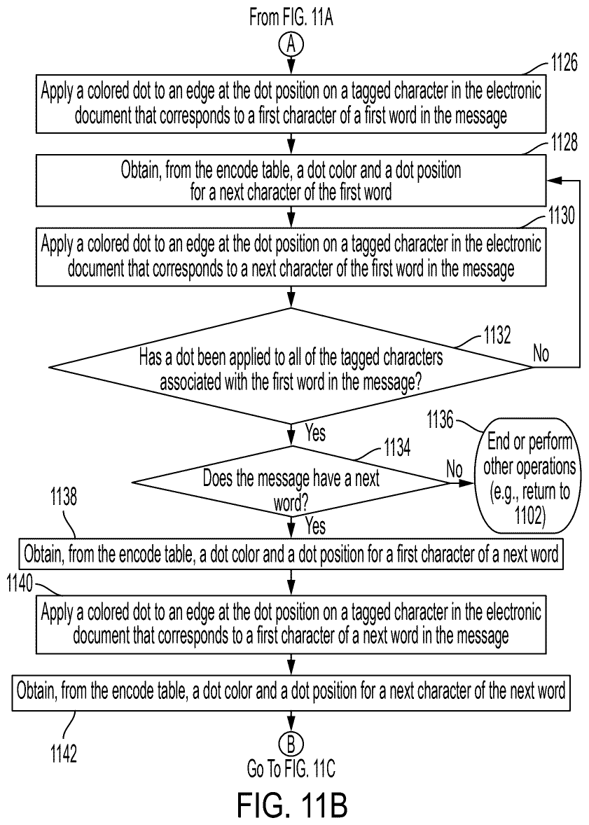

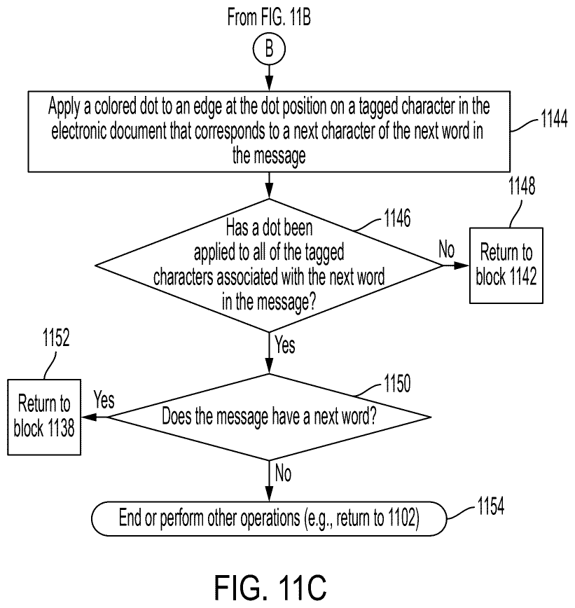

FIG. 11 provides a flow diagram of an illustrative method 1100 for operating a system (e.g., system 100 of FIG. 1, computing device 102, 120, 122, 124 of FIG. 1, controller 270 of FIG. 2, computing device 300 of FIG. 3, and/or processor 306 of FIG. 3). The operations of the blocks in FIG. 11 may be performed in the same or different order than the order shown, and/or may include more or less operations than that shown.

Method 1100 begins with 1102 and continues to optional block 1104 in which the system receives a message (e.g., user defined message 502′ of FIG. 5) that is to be encoded into an electronic document (e.g., electronic document 600 of FIG. 6). Next in 1106, the system accesses a first table (e.g., character mapping table 400 of FIG. 4) defining a character mapping. A character mapped message (e.g., character mapped message 502 of FIG. 5) is generated in block 1108. The character mapped message is generated by mapping each of the characters in the message to a mapping character in accordance with the defined character mapping.

The electronic document (e.g., electronic document 600 of FIG. 6) is obtained by the system in block 1110. The electronic document may be obtained from a local memory or a memory of a remote device. The electronic document can be in any format. For example, the electronic document comprises a Microsoft® Word document, a PDF document, a docx document, an excel document, a power point document, and/or a digital image. The present solution is not limited to the listed document formats.

In block 1112, the system performs optical character recognition to recognize characters (e.g., characters of interest 700 of FIG. 7) in the electronic document that are the same as the characters in the character mapped message. Each recognized character is tagged in the electronic document, as shown by block 1114. Any known or to be known technique for tagging content in an electronic document can be used here.

In block 1116, the system detects an edge of each tagged character. Any known or to be known edge detection algorithms can be used here. The detected edge is segmented into a plurality of edge sections (e.g., edge sections 802-812 of FIG. 8), as shown by block 1118. Each edge section is assigned in block 1120 to a category of a plurality of edge type categories (e.g., top-left, middle-left, bottom-left, top-right, middle-right, and/or bottom-right).

Next in block 1122, the system accesses an encode table (e.g., table 900 of FIG. 9) stored in a local or remote datastore. The system obtains, from the encode table, a dot color and a dot position for a first character of first word, as shown by block 1124. Method 1100 then continues to block 1126 of FIG. 11B. Block 1126 involves applying a colored dot (e.g., cyan dot 1000 of FIG. 10A) to an edge at the dot position on a tagged character in the electronic document that corresponds to a first character of a first word in the message. It should be noted that the colored dot may be applied in a manner that minimizes its visibility to viewers of the electronic document. For example, the colored dot is applied by ejecting ink at locations on a sheet of media corresponding to one or more pixels in image data. The visibility of the colored dot is minimized when it has a corresponding pixel size of one (1) to twenty (20) pixels. The present solution is not limited in this regard.

In next block 1128, the system obtains, from the encode table, a dot color and a dot position for a next character of the first word. A colored dot (e.g., cyan dot 1002 of FIG. 10A) is applied to an edge at the dot position on a tagged character in the electronic document that corresponds to a next character of the first word in the message.

Method 1100 continues with a decision block 1132 where the system determines whether a dot has been applied to all the tagged characters associated with the first word in the message. If not [1132: NO], then method 1100 returns to block 1128 and repeats the process for the next character in the first word. Otherwise [1132: YES], method 1100 continues to decision block 1134 where the system determines whether the message has a next word. If not [1134: NO], then method 1100 continues to block 1136 where it ends or other operations are performed (e.g., return to 1102). Otherwise [1134: YES], method 1100 continues to block 1138.

Block 1138 involves obtaining, from the encode table, a dot color and a dot position for a first character of a next word. A colored dot is applied in block 1140 to an edge at the dot position on a tagged character in the electronic document that corresponds to a first character of a next word in the message.

Next in block 1142, the system obtains, from the encode table, a dot color and a dot position for a next character of the next word. Method 1100 continues to block 1144 of FIG. 11C. Block 1144 involves applying a colored dot to an edge at the dot position on a tagged character in the electronic document that corresponds to a next character of the next word in the message. If a dot has been applied to all of the tagged characters associated with the next word in the message, method 1100 return to block 1142, as shown by block 1148. Otherwise, the system determines whether the message has a next word in block 1150. If so [1150: YES], method 1100 returns to block 1138 as shown by block 1152. If not [1150: NO], method continues to block 1154 where it ends or other operations are performed (e.g., return to 1102).

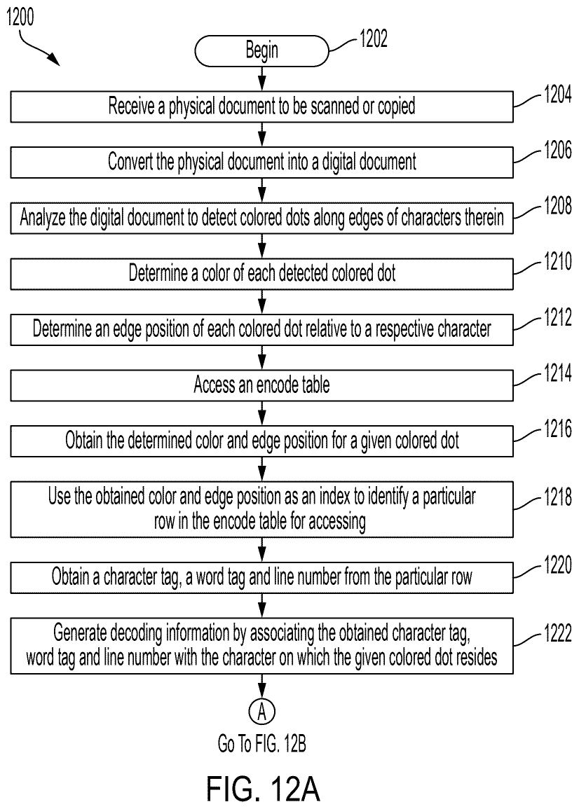

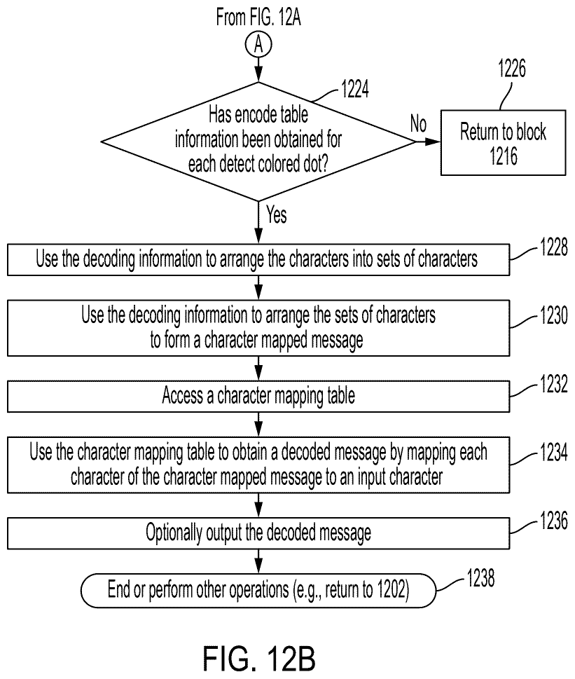

FIG. 12 provides a flow diagram of an illustrative method 1200 for operating a system (e.g., scanner 108 of FIG. 1, copier 110 of FIG. 1, and/or multifunctional device 112 of FIG. 1). The operations of the blocks in FIG. 11 may be performed in the same or different order than the order shown, and/or may include more or less operations than that shown.

Method 1200 begins with 1202 and continues to optional block 1204 in which the system receives a physical document to be scanned or copied. The system performs operations to convert the physical document into a digital document in block 1206. Any known or to be known technique for generating a digital document from a physical document can be used here.

The digital document is analyzed in block 1208 to detect colored dots along edges of characters therein. Any known or to be known technique for detecting colored dots in electronic documents can be used here. One such method is described in U.S. patent application Ser. No. 18/530,535 which is incorporated herein by reference in its entirety. The color of each detected colored dot is determined by the system in block 1210. The system also determines an edge position of each colored dot relative to a respective character, as shown by block 1212.

In block 1214, the system accesses an encode table (e.g., table 900 of FIG. 9). The determined color and edge position for a given colored dot are obtained by the system in block 1216, for example, from a local memory. The obtained color and edge position are used in block 1218 as an index to identify a particular row in the encode table for accessing. In block 1220, the system obtains a character tag, a word tag and a line number from the particular row identified in block 1218. The system generates decoding information in block 1222 by associating the obtained character tag, a word tag and a line number with the character on which the given colored dot resides. Method 1100 then continues to block 1224 of FIG. 12B.

As shown in FIG. 12B, block 1224 involves determining whether encode table information has been obtained for each detected colored dot. If not [1224: NO], method 1200 returns to block 1216 as shown by block 1226. Otherwise [1224: NO], method 1200 continues to blocks 1228-1230 where the system uses the decoding information to (i) arrange the characters into sets of characters and (ii) arrange the sets of characters to form a character mapped message (e.g., character mapped message 502 of FIG. 5).

Next in block 1232, the system accesses a character mapping table (e.g., character mapping table 400 of FIG. 4). The character mapping table is used by the system in block 1234 to obtain a decoded message by mapping each character of the character mapped message to an input character. The decoded message may be output by the system in block 1236 (e.g., visually, auditorily and/or tactically). Subsequently, method 1200 continues to block 1238 where it ends or other operations are performed (e.g., return to 1202).

In view of the forgoing, the present solution concerns implementing systems and methods for operating a system (e.g., system 100 of FIG. 1, computing device 102, 120, 122, 124 of FIG. 1, controller 270 of FIG. 2, computing device 300 of FIG. 3, and/or processor 306 of FIG. 3). The methods comprise: (i) obtaining, by a processor (e.g., computing device 102, 120, 122, 124 of FIG. 1, controller 270 of FIG. 2, computing device 300 of FIG. 3, and/or processor 306 of FIG. 3), a message in a human readable format (e.g., user defined message 502′ of FIG. 5); (ii) converting, by the processor, the human readable format of the message into a colored dot pattern format; (iii) encoding the message in an electronic document (e.g., electronic document 600 of FIG. 6) by applying colored dots (e.g., dots 1000-1030 of FIG. 10) to the electronic document in accordance with the colored dot pattern format and in a manner that minimizes visibility of the colored dots; (iv) printing the electronic document on a sheet of media to obtain a physical document with the encoded message; and/or (v) converting the physical document into a digital document and decoding the encoded message. The decoding the encoded message may comprise using the first dot color and the first dot position as an index for accessing a row in a table including information to facilitate the decoding.

Each of the colored dots may have a pixel size of, for example, one to twenty pixels, one to two pixels, one to three pixels, one to four pixels, one to five pixels, one to six pixels, one to seven pixels, one to eight pixels, one to nine pixels, one to ten pixels, one to eleven pixels, one to twelve pixels, one to thirteen pixels, one to fourteen pixels, one to fifteen pixels, and to sixteen pixels, one to seventeen pixels, one to eighteen pixels, or one to nineteen pixels.

The converter step (ii) may involve: accessing a first table defining a character mapping; generating a character mapped message by mapping each of a plurality of characters in the message to a mapping character in accordance with the character mapping; performing optical character recognition to recognize characters in the electronic document that are the same as the mapping characters in the character mapped message; obtaining tagged characters by tagging the recognized characters in the electronic document; detecting an edge of each tagged character of the tagged characters; segmenting the detected edge into a plurality of edge sections; assigning each edge section to a category of a plurality of edge type categories; accessing a second table defining an encoding technique; obtaining, from the second table, a first dot color and a first dot position for a first character of a first word; obtaining, from the second table, a second dot color and a second dot position for a second character of the first word; and/or obtaining, from the second table, another dot color and another dot position for a character of a second word.

The first dot of the colored dots may be applied to the edge at the first dot position on a first tagged character that corresponds to a first character in a first word in the message, the first dot having the first dot color. The first dot color and the first dot position may be obtained by using at least a character number and a word number associated with a respective character in the character mapped message as an index for accessing a row of the second table. A second dot of the colored dots may be applied to the edge at the dot position on a second tagged character that corresponds to a second character in the first word of the message. Another dot of the colored dots may be applied to the edge at another dot position on another tagged character that corresponds to a respective character in a second word of the message.

The present solution also concerns a system comprising: a processor; and a non-transitory computer-readable medium comprising one or more programming instructions that when executed by the processor, cause the processor to: obtain a message in a human readable format; convert the human readable format of the message into a colored dot pattern format; encode the message in an electronic document by applying colored dots to the electronic document in accordance with the colored dot pattern format and in a manner that minimizes visibility of the colored dots; control a printer to print the electronic document on a sheet of media to obtain a physical document with the encoded message; and/or convert the physical document into a digital document and decode the encoded message. The encoded message may be decoded by using the first dot color and the first dot position as an index for accessing a row in a table including information to facilitate the decoding.

The human readable format may be converted into a colored dot pattern by causing the processor to: access a first table defining a character mapping; generate a character mapped message by mapping each of a plurality of characters in the message to a mapping character in accordance with the character mapping; perform optical character recognition to recognize characters in the electronic document that are the same as the mapping characters in the character mapped message; obtain tagged characters by tagging the recognized characters in the electronic document; detect an edge of each tagged character of the tagged characters; segment the detected edge into a plurality of edge sections; assign each edge section to a category of a plurality of edge type categories; access a second table defining an encoding technique; obtain, from the second table, a first dot color and a first dot position for a first character of a first word; obtain a second dot color and a second dot position for a second character of the first word; and/or obtain, from the second table, another dot color and another dot position for a character of a second word.

The first dot of the colored dots may be applied to the edge at the first dot position on a first tagged character that corresponds to a first character in a first word in the message, the first dot having the first dot color. The first dot color and the first dot position may be obtained by using at least a character number and a word number associated with a respective character in the character mapped message as an index for accessing a row of the second table. The second dot of the colored dots may be applied to the edge at the dot position on a second tagged character that corresponds to a second character in the first word of the message. Another dot of the colored dots may be applied to the edge at another dot position on another tagged character that corresponds to a respective character in a second word of the message.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The described features, advantages and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

What is claimed is:

1. A method for operating a system, comprising:
obtaining, by a processor, a message in a human readable format;
converting, by the processor, the human readable format of the message into a colored dot pattern format; and
encoding the message in an electronic document by applying colored dots to the electronic document in accordance with the colored dot pattern format and in a manner that minimizes visibility of the colored dots.

2. The method according to claim 1, wherein each of the colored dots has a pixel size of one to twenty pixels.

3. The method according to claim 1, wherein the converting further comprises:
accessing a first table defining a character mapping; and
generating a character mapped message by mapping each of a plurality of characters in the message to a mapping character in accordance with the character mapping.

4. The method according to claim 3, wherein the converting further comprises:
performing optical character recognition to recognize characters in the electronic document that are the same as the mapping characters in the character mapped message; and
obtaining tagged characters by tagging the recognized characters in the electronic document.

5. The method according to claim 4, wherein the converting further comprises:
detecting an edge of each tagged character of the tagged characters;
segmenting the detected edge into a plurality of edge sections; and
assigning each edge section to a category of a plurality of edge type categories.

6. The method according to claim 5, wherein the converting further comprises:
accessing a second table defining an encoding technique; and
obtaining, from the second table, a first dot color and a first dot position for a first character of a first word;
wherein a first dot of the colored dots is applied to the edge at the first dot position on a first tagged character that corresponds to a first character in a first word in the message, the first dot having the first dot color.

7. The method according to claim 6, wherein the first dot color and the first dot position are obtained by using at least a character number and a word number associated with a respective character in the character mapped message as an index for accessing a row of the second table.

8. The method according to claim 6, wherein the converting further comprises:
obtaining, from the second table, a second dot color and a second dot position for a second character of the first word;
wherein a second dot of the colored dots is applied to the edge at the dot position on a second tagged character that corresponds to a second character in the first word of the message.

9. The method according to claim 8, wherein the converting further comprises:
obtaining, from the second table, another dot color and another dot position for a character of a second word;
wherein another dot of the colored dots is applied to the edge at the another dot position on another tagged character that corresponds to a respective character in a second word of the message.

10. The method according to claim 1, further comprising printing the electronic document on a sheet of media to obtain a physical document with the encoded message.

11. The method according to claim 10, further comprising converting the physical document into a digital document and decoding the encoded message.

12. The method according to claim 11, wherein the decoding the encoded message comprises using the first dot color and the first dot position as an index for accessing a row in a table including information to facilitate the decoding.

13. A system, comprising:
a processor; and
a non-transitory computer-readable medium comprising one or more programming instructions that when executed by the processor, cause the processor to:
obtain a message in a human readable format;
convert the human readable format of the message into a colored dot pattern format; and
encode the message in an electronic document by applying colored dots to the electronic document in accordance with the colored dot pattern format and in a manner that minimizes visibility of the colored dots.

14. The system according to claim 13, wherein each of the colored dots has a pixel size of one to twenty pixels.

15. The system according to claim 13, wherein the human readable format is converted into a colored dot pattern by causing the processor to access a first table defining a character mapping, and generate a character mapped message by mapping each of a plurality of characters in the message to a mapping character in accordance with the character mapping.

16. The system according to claim 15, wherein the human readable format is converted into a colored dot pattern by causing the processor to perform optical character recognition to recognize characters in the electronic document that are the same as the mapping characters in the character mapped message, and obtain tagged characters by tagging the recognized characters in the electronic document.

17. The system according to claim 16, wherein the human readable format is converted into a colored dot pattern by causing the processor to:
detect an edge of each tagged character of the tagged characters;
segment the detected edge into a plurality of edge sections; and
assign each edge section to a category of a plurality of edge type categories.

18. The system according to claim 17, wherein the human readable format is converted into a colored dot pattern by causing the processor to:
access a second table defining an encoding technique; and
obtain, from the second table, a first dot color and a first dot position for a first character of a first word;
wherein a first dot of the colored dots is applied to the edge at the first dot position on a first tagged character that corresponds to a first character in a first word in the message, the first dot having the first dot color.

19. The system according to claim 18, wherein the first dot color and the first dot position are obtained by using at least a character number and a word number associated with a respective character in the character mapped message as an index for accessing a row of the second table.

20. The system according to claim 18, wherein the human readable format is converted into a colored dot pattern by causing the processor to:
obtain a second dot color and a second dot position for a second character of the first word;
wherein a second dot of the colored dots is applied to the edge at the dot position on a second tagged character that corresponds to a second character in the first word of the message.

21. The system according to claim 19, wherein the human readable format is converted into a colored dot pattern by causing the processor to:
obtain, from the second table, another dot color and another dot position for a character of a second word;
wherein another dot of the colored dots is applied to the edge at the another dot position on another tagged character that corresponds to a respective character in a second word of the message.

22. The system according to claim 13, wherein the processor is further caused to control a printer to print the electronic document on a sheet of media to obtain a physical document with the encoded message.

23. The system according to claim 22, wherein the processor is further caused to convert the physical document into a digital document and decode the encoded message.

24. The system according to claim 23, wherein the encoded message is decoded by using the first dot color and the first dot position as an index for accessing a row in a table including information to facilitate the decoding.
